(19) United States
(12) Patent Application Publication
(10) Pub. No.: US 2004/0006760 A1
(43) Pub. Date: Jan. 8, 2004

(54) Generating and using profile information automatically in an integrated development environment

(76) Inventors: Darryl J. Gove, Santa Clara, CA (US); Jennifer L. Gove, Santa Clara, CA (US)

Correspondence Address: Stephen A. Terrile, Attorney for Applicant(s), HAMILTON & TERRILE, LLP, PO Box 203518, Austin, TX, 78720, US

(21) Appl. No.: 10/191,355

(22) Filed: Jul. 8, 2002

(51) Int. Cl. G06F 9/44; G06F 9/45

(52) U.S. Cl. 717/100; 717/124; 717/151

(57) ABSTRACT

A method for developing a software program using an integrated development environment which includes writing code within the integrated development environment, debugging the code while within the integrated development environment, profiling the code while within the integrated development environment, and revising the code based upon the debugging and profiling.

### BACKGROUND OF THE INVENTION

1. Field of the Invention

The invention relates to using an integrated development environment (IDE) and more particularly to using profiles in an integrated development environment to improve application performance

2. Description of the Related Art

When a computer program executes on a computer system, the ‘profile’ of the computer program represents the time spent in the various routines which comprise the computer program or application. The process of collecting information relating to the time spent in the various routines is referred to as profiling. The tool which collects the profile information is often referred to as a profiler.

Profiles are useful in determining where performance bottlenecks are within the computer program, and where the code of the computer program needs to be modified to improve performance of the computer program.

Collecting a profile of an application actually introduces some error in the timing of the execution of the computer program. For example, a computer program may run slightly slower due to the profiling (referred to as a probe effect). Advances in profiler technology have reduced the probe effect to virtually unobservable levels in the case of most applications.

An Integrated Development Environment (IDE) is an environment for developing applications. Typically, the IDE includes an editor for modifying the source code, a compiler for converting the source code into machine code, a debugger for locating bugs in the program, and a profiler for collecting profiles of the application.

The process that developers generally use when developing applications is as follows. The developer generally writes or codes an application so that the program functions properly. The program is then executed. The debugger is used when there are problems in the execution of the program; the debugger is used until the application is problem (bug) free. After the debug is completed, then the developer may execute a profiler to collect performance data on the program. Based upon the performance data, the developer fixes the performance problems. The process of modifying the code for an application based upon profile data is often referred to as performance optimization. After the performance problems have been addressed then the development of the program is completed. FIG. 1, labeled Prior Art, shows a flow chart of this development process.

The Forte Developer available from Sun Microsystems includes a profiler called Forte Analyzer. Additionally, Intel has a profiler referred to as the VTune profiler. In a survey of developers, most did not use a profiler to improve the performance of their code. Often, the use of profiling tools is viewed as a specialist activity.

Generally profiles are collected as a separate stage in the development process. Often profiling is done as the final stage of the program development which occurs after the bugs have been removed from the application. Accordingly, performance optimization is either done at the end of the process when there are fewer degrees of freedom for code changes, and less time to do the changes, or the performance optimization is neglected entirely.

### SUMMARY OF THE INVENTION

The present invention relates to making performance profiling easily available to developers. By making performance profiling easily available to developers during the development process, program performance is improved and development cycle times are reduced.

In one embodiment, the invention relates to a method for developing a software program using an integrated development environment which includes writing code within the integrated development environment, debugging the code while within the integrated development environment, profiling the code while within the integrated development environment, and revising the code based upon the debugging and profiling.

In another embodiment, the invention relates to an integrated development environment which includes a code writing portion, a debugging portion, a profiling portion and a revising portion. The code writing module enables a programmer to write code for a program while within the integrated development environment. The debugging portion enables a programmer to debug the code while within the integrated development environment. The profiling portion profiles the code while within the integrated development environment. The revising portion enables a programmer to revise the code based upon the debugging and profiling.

In another embodiment, the inventions relates to a method for developing a software program using an integrated development environment which includes presenting performance data attributable to respective lines of code within the integrated development environment, and revising the code based upon the performance data.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1, labeled prior art, shows a flow chart of a known development process.

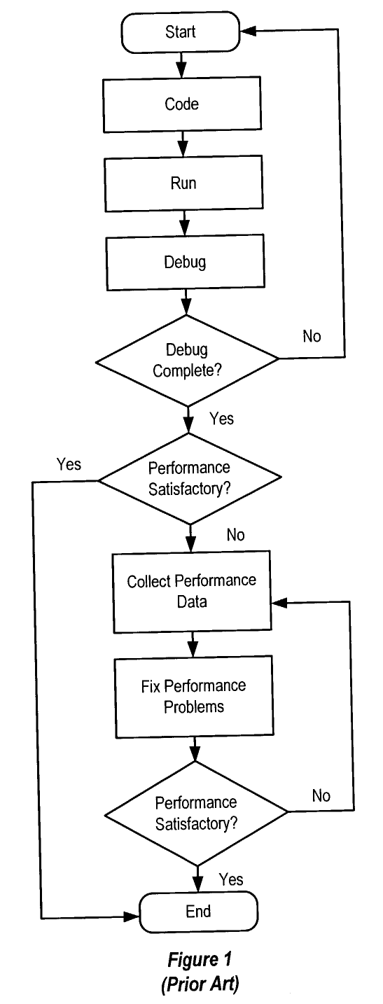

FIG. 2 shows a flow chart of a development process in accordance with the present invention.

FIG. 3 shows an example of a screen presentation of an IDE development process in accordance with the present invention.

FIG. 4 shows a block diagram of an IDE which includes a profiler in accordance with the present invention.

### DETAILED DESCRIPTION

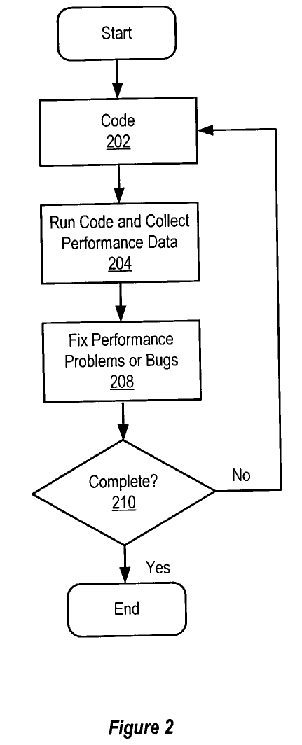

Referring to FIG. 2, a flow chart of a development process in accordance with the present invention is shown. More specifically, a developer starts the development process by coding a program at step 202. After a version of the program is coded, then the IDE executes the code and collects performance data at step 204. After the performance data is collected by the IDE, then the developer reviews the performance data and debugs the program (i.e., fixes execution problems of the program) at step 208. If the developer notices either bugs in the application which require fixing, or that a particular part of the code has a performance issue (i.e., problems relating to execution speed), then these issues are addressed at step 208. Once the developer is satisfied that the application is both bug free and meets the performance criteria at step 210, then the development process finishes. If there are additional functional problems or performance problems, then the process returns to code step 202 to address the additional functional problems or performance problems.

Using the development process of the present invention, using an IDE, a programmer develops, compiles, runs, debugs and profiles the code from within the IDE. Because the IDE is integrated, if the compiler reports a problem, then the line which causes the problem is highlighted. Similarly if the program crashes, then the line which caused the crash is highlighted. Additionally, the IDE always executes the application (unless the developer specifically forbids it) under the profiler. Accordingly, every run of the application returns a set of data which shows how the time was distributed amongst the source code of the application.

The execution of the profiler within the IDE is user configurable. Thus, the programmer can switch the profiler off, if for example, the code is timing critical, or if the probe effect of the profiling is too great.

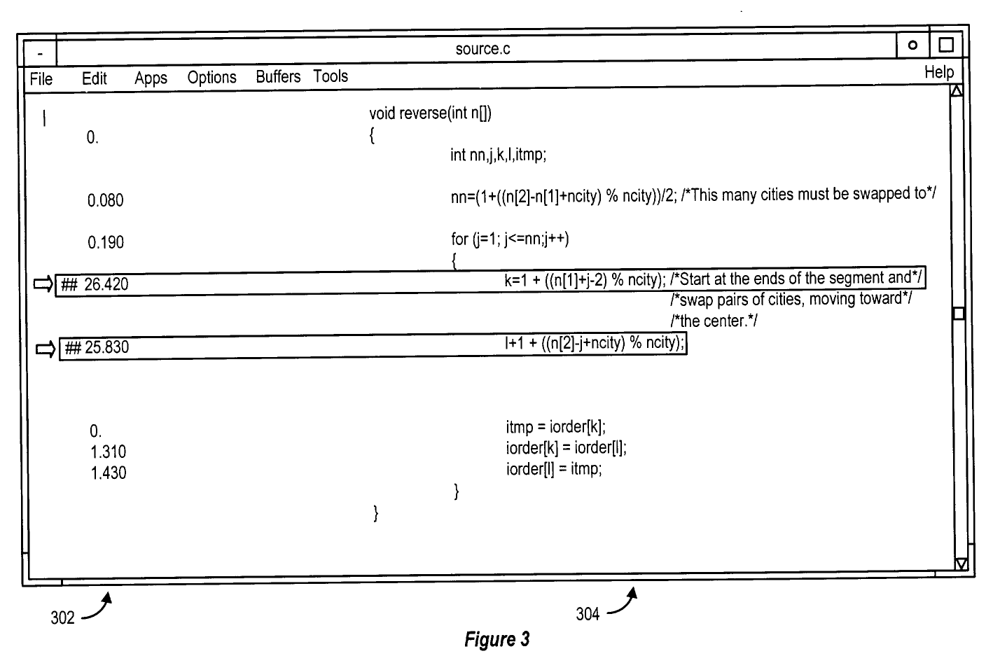

Referring to FIG. 3, the profiling data 302 is shown as time attributed to lines of code 304 in the program. More specifically, the execution time is shown attributed to one or all of lines of source code, lines of machine code, or functions (or possibly other levels of abstraction like source files, or libraries). Accordingly, the functionality of the profiler merges into the functionality of the IDE.

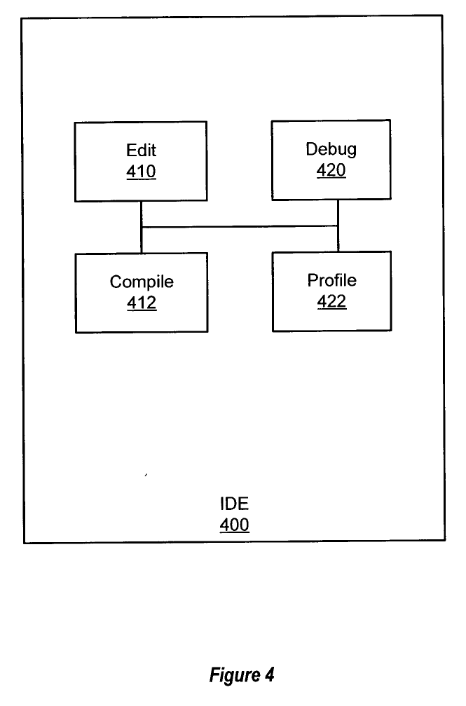

Referring to FIG. 4, an IDE 400 in accordance with the present invention is shown. More specifically, the IDE 400 includes an edit portion 410, a compile portion 412, a debug portion 420 and a profile portion 422. IDE 400 is similar to known IDE's such as the Forte Developer available from Sun Microsystems. However, the IDE of the present invention further includes an integrated, automatically executed profile portion 422. The profile portion 422 includes a plurality of configurable options that may be set by the developer.

For example, the profile portion 422 of the IDE 400 includes an option of indicating when time is unattributable based upon modifications to the code. More specifically, if the source code is modified, then the timing information for the modified part of the source code should be recalculated. For example, if a routine takes 10 seconds in total to execute, and 5 seconds of this time is spent in a loop in the routine, then the integrated profiler would label the loop with 5 seconds of time. However, if the programmer then decides that this loop is unnecessary and removes it, then the integrated profiler would recalculate the time attributed to the execution of this routine. One method of recalculating this time is by setting forth that the routine took 10 seconds of time to execute, but that the profiler is now unable to attribute that time to particular lines. The correct statistics are then calculated on the next profiling run of the program.

The profile portion 422 also includes an option relating to when multiple runs of the program generate different data. For example, every run of the program (after a source code change or recompile) generates a fresh set of data, and the previous set of data is discarded. If the source code has been modified, or the source has been recompiled, then the profile will be different. The improved IDE 400 of the invention allows the user to collect profiles from different executions of the code and to selectively store the different profiles.

Another option of the profile portion 422 relates to the availability of a history of statistics, enabling the developer to track performance. Note that with source code modifications etc. these statistics may not always be at the finest level of detail. A further option for the implementation is that a history of profiles would be kept with a corresponding list of modifications that the application underwent. Thus, if the programmer later discovers a change that reduced (rather than improved) performance, the programmer would be able to see what the change was and undo the change if necessary. This is an extension of the core invention, and not a critical part of it.

IDE 400 may augment rather than replace a separate profiling tool. Thus, the level of detail that is displayed by the profile portion 422 of the IDE 400 may be less than if a profiler were executed separately. To examine the profile data in more detail it may be the case that the developer has the option to execute a discrete profiler. For example, if the most recently collected profile indicates that one particular line takes a lot of time, it may be an option for the developer to select that particular line and launch the separate profiler to explore the code for that one line in more depth.

In one embodiment, the profiling information provided by the profile portion 422 may be presented by highlighting the time consuming functions with an icon, a color change (see e.g., FIG. 3) or other highlighting method. A user configurable option may be set to determine how much time a function uses before the function is presented as a time consuming function.

For more advanced users of the IDE 400, it is useful to have the facility to attribute time to lines of source code or machine code. The IDE 400 provides a user configurable option to allow attributing time to lines of code.

Another user configurable option of the IDE 400 relates to when the application does not run for a sufficient amount of time for meaningful data to be collected. In this situation, the profiler may suppress the display of performance data. Alternatively, when an application is executing for a long time, the developer may suppress the display of data or use other data management tools to deal with the large volume of data that is generated by the long execution.

By providing the IDE with the various user configurable options, the IDE is capable of providing grades of information. Such a configurable IDE 400 enables a user to determine a desired level of detail. The various user configurable options also enable the user to determine how much information is displayed while developing an application.

Other Embodiments

Other embodiments are within the following claims.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

The above-discussed embodiments include software modules that perform certain tasks. The software modules discussed herein may include script, batch, or other executable files. The software modules may be stored on a machine-readable or computer-readable storage medium such as a disk drive. Storage devices used for storing software modules in accordance with an embodiment of the invention may be magnetic floppy disks, hard disks, or optical discs such as CD-ROMs or CD-Rs, for example. A storage device used for storing firmware or hardware modules in accordance with an embodiment of the invention may also include a semiconductor-based memory, which may be permanently, removably or remotely coupled to a microprocessor/memory system. Thus, the modules may be stored within a computer system memory to configure the computer system to perform the functions of the module. Other new and various types of computer-readable storage media may be used to store the modules discussed herein. Additionally, those skilled in the art will recognize that the separation of functionality into modules is for illustrative purposes. Alternative embodiments may merge the functionality of multiple modules into a single module or may impose an alternate decomposition of functionality of modules. For example, a software module for calling sub-modules may be decomposed so that each sub-module performs its function and passes control directly to another sub-module.

Consequently, the invention is intended to be limited only by the spirit and scope of the appended claims, giving full cognizance to equivalents in all respects.

What is claimed is:

1. A method for developing a software program using an integrated development environment comprising
writing code within the integrated development environment;
debugging the code while within the integrated development environment;
profiling the code while within the integrated development environment; and
revising the code based upon the debugging and profiling.

2. The method of claim 1 wherein
the profiling includes a plurality of configurable options, the plurality of configurable options being settable by a user.

3. The method of claim 2 wherein
the plurality of configurable options includes an option of indicating when time is unattributable based upon modifications to the code.

4. The method of claim 2 wherein
the plurality of configurable options includes an option relating to when multiple runs of the code generate multiple versions of profiling data.

5. The method of claim 2 wherein
the plurality of configurable options includes an option relating to collecting a history of statistics relating to performance.

6. The method of claim 2 wherein
the plurality of configurable options includes an option allowing attributing execution time to respective lines of code.

7. The method of claim 2 wherein
the plurality of configurable options includes an option relating to suppressing displaying performance data when the performance data is not meaningful.

8. The method of claim 2 wherein
the plurality of configurable options includes an option relating to highlighting time consuming functions when presenting performance data.

9. The method of claim 1 wherein the profiling is performed every time the code is executed while within the integrated development environment.

10. An integrated development environment comprising
a code writing portion, the code writing module enabling a programmer to write code for a program while within the integrated development environment;
a debugging portion, the debugging portion enabling a programmer to debug the code while within the integrated development environment;
a profiling portion, the profiling portion profiling the code while within the integrated development environment; and
a revising portion, the revising portion enabling a programmer to revise the code based upon the debugging and profiling.

11. The integrated development environment of claim 10 wherein
the profiling portion includes a plurality of configurable options, the plurality of configurable options being settable by a user.

12. The integrated development environment of claim 11 wherein
the plurality of configurable options includes an option of indicating when time is unattributable based upon modifications to the code.

13. The integrated development environment of claim 11 wherein
the plurality of configurable options includes an option relating to when multiple runs of the code generate multiple versions of profiling data.

14. The integrated development environment of claim 11 wherein
the plurality of configurable options includes an option relating to collecting a history of statistics relating to performance.

15. The integrated development environment of claim 11 wherein
the plurality of configurable options includes an option allowing attributing execution time to respective lines of code.

16. The integrated development environment of claim 11 wherein
the plurality of configurable options includes an option relating to suppressing displaying performance data when the performance data is not meaningful.

17. The integrated development environment of claim 11 wherein
the plurality of configurable options includes an option relating to highlighting time consuming functions when presenting performance data.

18. The integrated development environment of claim 10 wherein the profiling is performed every time the code is executed while within the integrated development environment.

19. A method for developing a software program using an integrated development environment comprising
presenting performance data attributable to respective lines of code within the integrated development environment; and,
revising the code based upon the performance data.

20. The method of claim 19 further comprising
suppressing displaying performance data when the performance data is not meaningful.

21. The method of claim 19 further comprising
highlighting time consuming functions when presenting the performance data.

22. The method of claim 21 wherein
determining time consuming functions is set by a user.
